(19) United States
(12) Patent Application Publication
(10) Pub. No.: US 2010/0025483 A1
(43) Pub. Date: Feb. 4, 2010

(54) Sensor-Based Occupancy and Behavior Prediction Method for Intelligently Controlling Energy Consumption Within a Building

(76) Inventors: Michael Hoeynck, Bridgeville, PA (US); Burton W. Andrews, Pittsburgh, PA (US)

Correspondence Address: TAFT STETTINIUS & HOLLISTER LLP, ONE INDIANA SQUARE, SUITE 3500, INDIANAPOLIS, IN, 46204, US

(21) Appl. No.: 12/183,361

(22) Filed: Jul. 31, 2008

(51) Int. Cl. G05D 23/30

(52) U.S. Cl. 236/1 C

(57) ABSTRACT

A method for controlling energy consumption within a building includes providing at least one environment sensing device and at least one energy consumption sensing device associated with the building. Current data is collected from the environment sensing device and the energy consumption sensing device along with associated time-of-day data. A value of a future energy consumption parameter is predicted based upon the collected current data, the associated time-of-day data, and historic data collected from the environment sensing device and the energy consumption sensing device. A profile of future costs per unit of energy consumption as a function of time is determined. Energy consumption is controlled dependent upon the predicted future energy consumption parameter value and the determined profile of energy consumption costs.

### COPYRIGHT NOTICE

Portions of this document are subject to copyright protection. The copyright owner does not object to facsimile reproduction of the patent document as it is made available by the U.S. Patent and Trademark Office. However, the copyright owner reserves all copyrights in the software described herein and shown in the drawings. The following notice applies to the software described and illustrated herein: Copyright© 2008, Robert Bosch GmbH, All Rights Reserved.

### BACKGROUND

1. Field of the Invention

The present invention relates to a method for controlling energy consumption within a building, and, more particularly, to a method for controlling energy consumption within a building in response to sensor outputs.

2. Description of the Related Art

Energy prices are widely varying on a daily basis and are steadily increasing. Minimization of heating and air conditioning costs for a building, while maintaining comfort, must be based on identification of devices and systems used within the building as well as on a characteristic of user behavior and the building environment. Based on the identification of system components, building controls can optimize comfort and energy based on defined comfort levels and actual use of the building space.

It is known for an HVAC system for a building such as a house, office building or warehouse to be controlled according to a set daily or weekly schedule. That is, an electronic controller may establish a series of set temperatures that the HVAC system may be operated to achieve at certain times of the day. The set temperatures and associated times may vary depending on the day of the week. The times and set temperatures may be selected by a human programmer based upon a number of people expected to be in the building at various times. For example, in order to reduce energy costs, the building may not be maintained at a comfortable temperature when only a few or less people are expected to be in the building. The times and set temperatures may also be selected based upon a known response time of the ambient temperature within the building to a change in the set temperature of the HVAC system. That is, depending on weather conditions and the amount of heat generated by machines and appliances within the building, the length of time required for an HVAC system to achieve a new set temperature may vary.

A problem with such known HVAC control systems is that the time periods during which a building will be occupied are not always well known. Even in instances wherein occupancy times are well known, the time periods of occupancy are liable to change from week to week. Even when changes in occupancy schedules are known, the HVAC control system is often not re-programmed according to the new schedule because either no one who knows how to re-program the system is available, re-programming is considered to be too difficult of a task, or re-programming of the HVAC control system is completely forgotten about. Thus, when changes in occupancy schedules take place, the HVAC system is often operated when it need not be, and/or occupants suffer through uncomfortable temperatures when the HVAC system is shut down.

Another problem is that, because HVAC control system programmers are aware of the uncertainty of future occupancy schedules, the programmers intentionally err on the side of operating the HVAC for too great a portion of the day. Although this practice may result in more comfort for the occupants, it certainly results in instances of the HVAC system operating when there is no need for it to do so.

What is neither anticipated nor obvious in view of the prior art is a method for controlling an HVAC system such that the system operates only when needed based on actual occupancy.

### SUMMARY OF THE INVENTION

The present invention provides a method for sensing current human occupancy of a building as well as current energy consumption characteristics in order to predict HVAC operation requirements in the ensuing several hours in view of past occupancy and energy consumption patterns.

In one embodiment, the present invention uses sensing technology and a systems-identification approach to determine relationships between occupant behavior, device signatures and environmental cues. Occupant behavior may include parameters such as occupancy, mobility patterns, comfort preferences, and device usage. Device signatures may include temporal/frequency patterns of voltage, current, and/or phase. Environmental cues may include parameters such as temperature, humidity, carbon dioxide, illumination, and acoustics. The invention may also use pattern recognition and classification techniques to derive a sensor-based behavioral prediction algorithm reaching several hours into the future. This model-based prediction may be used as a baseline for the development of control and optimization techniques.

The present invention may be based on a systems approach including a novel infrastructure for commercial and residential building applications. A novel feature is the use of sensors to identify electrical systems and to assess environmental parameters and the interaction between people and the building. Such use of sensors may provide cues for systems optimization toward lower energy consumption while still providing a high level of comfort to the occupants.

The invention comprises, in one form thereof, a method for controlling energy consumption within a building, including providing at least one environment sensing device and at least one energy consumption sensing device associated with the building. Current data is collected from the environment sensing device and the energy consumption sensing device along with associated time-of-day data. A future value of an energy consumption parameter is predicted based upon the collected current data, the associated time-of-day data, and historic data collected from the environment sensing device and the energy consumption sensing device. A profile of future costs per unit of energy consumption as a function of time is determined. Energy consumption is controlled dependent upon the predicted future energy consumption parameter value and the determined profile of energy consumption costs.

The invention comprises, in another form thereof, a method for controlling energy consumption within a building, including providing at least one human presence sensing device and at least one energy consumption sensing device associated with the building. Current data is collected from the human presence sensing device and the energy consumption sensing device along with associated time-of-day data. A future value of a human presence parameter is predicted based upon the collected current data, the associated time-of-day data, and historic data collected from the human presence sensing device and the energy consumption sensing device. Energy consumption is controlled dependent upon the predicted future value of the human presence parameter.

The invention comprises, in yet another form thereof, a method for controlling HVAC operation within a building, including providing at least one environment sensing device associated with the building. Current data is collected from the environment sensing device. A future temperature associated with the building is predicted based upon the collected current data, and historic data collected from the environment sensing device. Operation of an HVAC system is controlled dependent upon the predicted future temperature.

In addition to controlling HVAC operation within a building, the present invention may be used to control other forms of energy consumption, including management of hot water systems, local power generation (e.g., photovoltaics, buying/selling from utilities based on real-time pricing, energy storage), and load scheduling (e.g., start times of appliances such as washer, dryer, dishwasher, etc.).

An advantage of the present invention is that energy costs may be reduced without sacrificing comfort level.

### BRIEF DESCRIPTION OF THE DRAWINGS

The above mentioned and other features and objects of this invention, and the manner of attaining them, will become more apparent and the invention itself will be better understood by reference to the following description of an embodiment of the invention taken in conjunction with the accompanying drawings, wherein:

FIG. 1 is a block diagram of one embodiment of a sensor-based HVAC control system suitable for use with a building energy consumption control method of the present invention.

FIG. 2 is a block diagram of a learning algorithm/predictor suitable for use with a building energy consumption control method of the present invention.

FIG. 3 is a flow chart illustrating one embodiment of a method of the present invention for controlling energy consumption within a building.

FIG. 4 is a flow chart illustrating another embodiment of a method of the present invention for controlling energy consumption within a building.

FIG. 5 is a flow chart illustrating yet another embodiment of a method of the present invention for controlling energy consumption within a building.

FIG. 6 is a flow chart illustrating one embodiment of a method of the present invention for controlling HVAC operation within a building.

Corresponding reference characters indicate corresponding parts throughout the several views. Although the drawings represent embodiments of the present invention, the drawings are not necessarily to scale and certain features may be exaggerated in order to better illustrate and explain the present invention. Although the exemplification set out herein illustrates embodiments of the invention, in several forms, the embodiments disclosed below are not intended to be exhaustive or to be construed as limiting the scope of the invention to the precise forms disclosed.

### DETAILED DESCRIPTION

Some portions of the following description are presented in terms of algorithms and operations data. Unless otherwise stated herein, or apparent from the description, terms such as “calculating”, “collecting”, “controlling”, “determining”, “predicting”, “processing” or “computing”, or similar terms, refer the actions of a computing device that may perform these actions automatically, i.e., without human intervention, after being programmed to do so.

The embodiments hereinafter disclosed are not intended to be exhaustive or limit the invention to the precise forms disclosed in the following description. Rather the embodiments are chosen and described so that others skilled in the art may utilize its teachings.

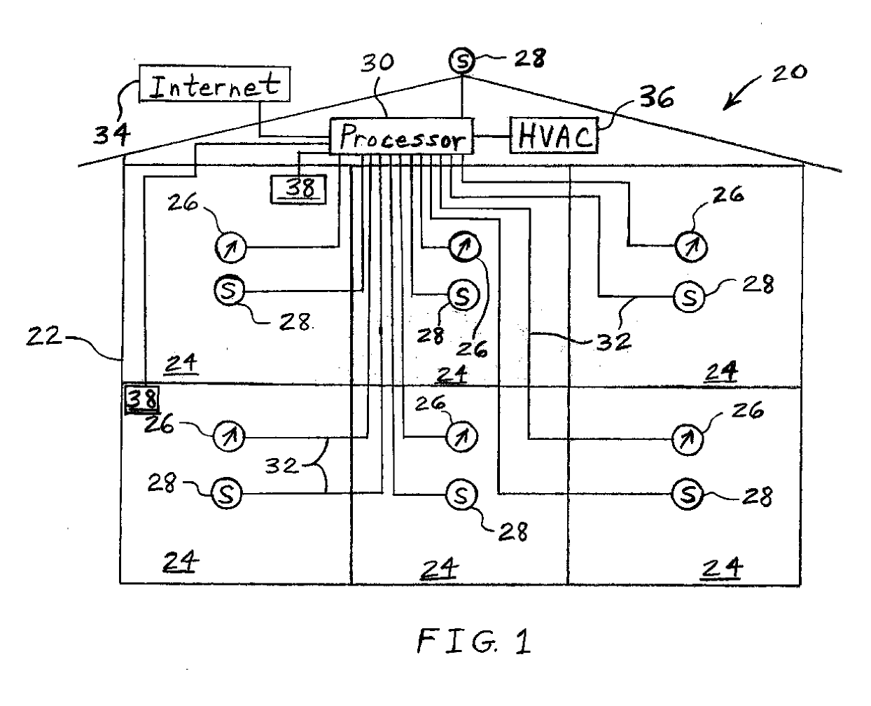

Referring now to FIG. 1, there is shown one embodiment of a sensor-based HVAC control system 20 of the present invention including a building 22 having a plurality of rooms 24. Within each room 24, there may be one or more energy consumption sensing device 26 and one or more environment sensing device 28. Energy consumption sensing devices 26 may sense one or more characteristic of the consumption of some utility, such as electricity or natural gas. For example, energy consumption sensing devices 26 may sense voltage, current, power and/or phase of the electricity being consumed, and may monitor and record changes in these parameters with time.

Environment sensing devices 28 may sense any of various parameters associated with the environment inside and outside building 22, including the presence of human beings. In order to sense environmental parameters outside building 22, at least one environment sensor 28 may be disposed outside of building 22, as illustrated in FIG. 1. Environment sensing devices 28 may sense environmental parameters such as temperature, humidity, moisture, wind speed and light levels, all of which may have a bearing on future temperatures, and/or rates of temperature change, within building 22. Environment sensing devices 28 may sense environmental parameters indicative of the presence of human beings or animals, such as motion, door movements, sound levels, carbon dioxide levels, and electronic card readings. Electronic card readings may be sensed in work environments in which employees scan their personal identification card in a card reader when entering or exiting the building.

Each of sensing devices 26, 28 may be in electronic communication with a central electronic processor 30. Although devices 26, 28 are shown in FIG. 1 as being connected to processor 30 via respective electrical conductors 32, it is also possible within the scope of the invention for devices 26, 28 to be in wireless communication with processor 30.

Processor 30 may be in electronic communication with the Internet 34 via which processor 30 may receive current profiles of future costs per unit of energy consumption as a function of time. For example, processor 30 may receive a schedule of electricity costs at various times of the day, which processor 30 may use in deciding when and/or whether to operate various electrical devices, such as heating ventilating and air conditioning (HVAC) system 36 and appliances 38 such as ovens, clothes dryers, etc. HVAC system 36, under the control of processor 30, may be capable of managing the ambient temperature in each of rooms 24 individually. That is, HVAC system 36 may be capable of achieving desired set temperatures on a room-by-room basis.

Control system 20 may utilize sensor device 26, 28 coupled with pattern recognition and learning algorithms to predict the behavior of human occupants of building 22 several hours into the future based on prior occupant levels and behavior. A horizon of several hours may be chosen because the thermal mass of a building is typically such that the effect of operating an HVAC system may be felt for several hours into the future. Stated differently, the temperature within a building may be function of the outside ambient temperatures and the building's HVAC operation within only the previous several hours, and may be substantially unrelated to and unaffected by what the temperature in the building was more than several hours ago.

Environment sensors 28 may measure indoor and outdoor environmental conditions (e.g., temperature, humidity, carbon dioxide, illumination, motion activity, and sound). Energy consumption sensing devices 26 may measure characteristics of operating appliances and devices in the building (e.g., AC/DC current, voltage, phase and frequency harmonics). Machine learning algorithms may extract higher-level features from these sensed physical parameters such as the number of people in the room, the use of a specific appliance, or a particular activity of the occupant such as cooking, bathing, etc. Temporal patterns in both the data and high-level features may be discovered and used in forecasting upcoming activity. These predictions may be fed into a building automation system that optimally balances the tradeoff of comfort and energy-efficient management of building systems such as HVAC (e.g., residential heating/cooling or commercial ventilation), hot water, local power generation (e.g., photovoltaics, buying/selling from utilities based on real-time pricing, energy storage), as well as load scheduling (e.g., delayed start of appliances such as washer, dryer, dishwasher, etc.).

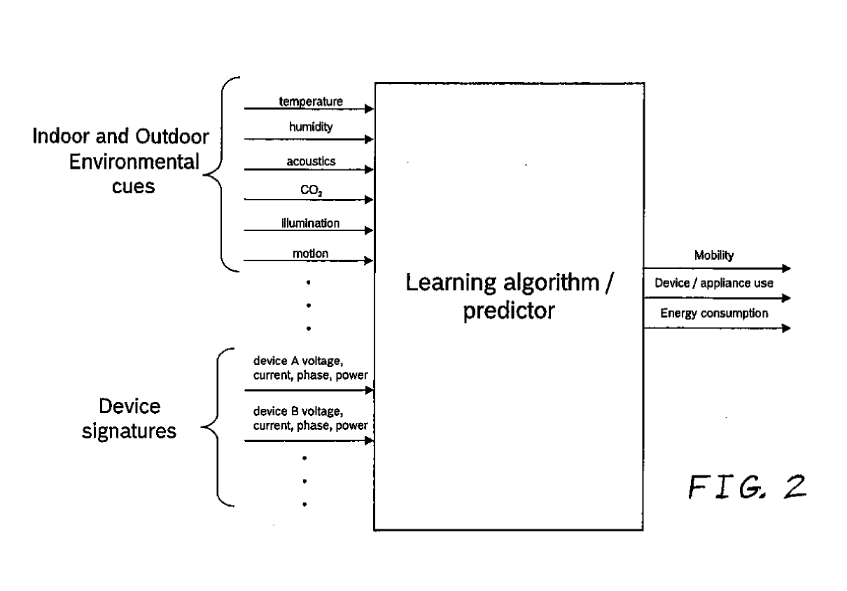

FIG. 2 illustrates exemplary inputs and outputs of a learning algorithm/predictor embodied within processor 30. The predictor receives indoor and outdoor environmental cues provided by environment sensing devices 28, including temperature, humidity, acoustics, carbon dioxide, illumination and motion, among others. The predictor also receives device or appliance electrical power consumption signatures including voltage, current, phase and power for each device.

Based upon the above-described inputs, times-of-day associated with the inputs, historic data relating previous outputs to associated previous inputs, and times-of-day associated with the previous inputs and previous outputs, the learning algorithm/predictor may output several predictions. The outputs may be related to the mobility of the building's occupants (e.g., movement of the occupants in and out of the building as well as between rooms), use of devices and appliances, and energy consumption, for example.

As one example of an implementation scenario of the present invention, environment sensing devices 28 may detect consistent increases in temperature, humidity, and acoustic levels in a bathroom of building 22 which are consistent with use of the bathroom shower. Moreover, energy consumption sensing devices 26 may concurrently indicate increased use of natural gas or electricity to heat water, and increased flow of hot water, and/or and increased consumption of electrical power when operating a hair dryer. Processor 30 may analyze previous data patterns and conclude that such incoming data is usually followed by continued human occupancy within the bathroom for at least twenty minutes, as detected by motion sensors, for example. Analysis of previous data may also reveal that such incoming data is usually followed by continued human occupancy within building 22 for at least thirty minutes, as also detected by motion sensors or other types of human presence sensing devices. Because processor 30 concludes that the bathroom will be occupied for at least twenty more minutes and building 22 will be occupied for at least thirty more minutes, processor 30 may decide to continue operation of HVAC system 36, or at least continue providing heat within the bathroom where it is particularly needed. Otherwise, if processor 30 had no data to indicate that building 22 would continue to be occupied for any length of time, then processor 30 may inhibit operation of HVAC system 36 based on the possibility that building 22 may soon be unoccupied.

As another example of an implementation scenario of the present invention, energy consumption sensing devices 26 may detect consistent use of an appliance 38 such as an oven. Oven use may be indicated by periodic appearances of similar temporal patterns in power consumption at certain times of the day, or with certain frequencies of occurrence, that are consistent with typical cooking schedules. Oven use may also be indicated or confirmed by otherwise unexplained spikes in ambient temperature within the kitchen, as measured by environment sensing devices 28, which may also occur at certain times of the day, or with certain frequencies of occurrence, that are consistent with typical cooking schedules. Processor 30 may analyze previous data patterns and conclude that such data indicative of cooking is usually followed by continued human occupancy within the kitchen for at least ten minutes, as detected by motion sensors, for example. Analysis of previous data may also reveal that such incoming data is usually followed by continued human occupancy within building 22 for at least sixty minutes, as also detected by motion sensors or other types of human presence sensing devices. Because processor 30 concludes that the kitchen will be occupied for at least ten more minutes and building 22 will be occupied for at least sixty more minutes, processor 30 may decide to continue operation of HVAC system 36, or at least continue providing air conditioning within the kitchen where it is particularly needed. Otherwise, if processor 30 had no data to indicate that building 22 would continue to be occupied for any length of time, then processor 30 may inhibit operation of HVAC system 36 based on the possibility that building 22 may soon be unoccupied.

As another example of an implementation scenario of the present invention, environment sensing devices 28 may detect high levels of illumination (i.e., light) in a bedroom coupled with a lack of motion and low acoustic levels, which may correspond to reading behavior at night. Such data may particularly be interpreted as being indicative of reading behavior if the data is received in the late evening or a time-of-day typically associated with bedtimes. Processor 30 may be programmed, if desired by the user, to respond to such data indicative of bedtime reading by discontinuing or inhibiting operation of HVAC system 36, or at least lowering the set point temperature below which heat is turned on. Processor 30 may be programmed to apply these actions to either the entire building 22 or only to the bedroom. Otherwise, if processor 30 had no data to indicate that the occupant is preparing to go to bed for the night, then processor 30 may continue operation of HVAC system 36 for the comfort of active occupants of building 22.

Energy consumption sensing devices 26 may identify various characteristics of energy consumption and processor 30 may draw conclusions therefrom as to the type of load that is consuming the energy. Based upon the types of machines and appliances that are operating, processor 30 may make assumptions as to both the amount of heat generated by the machines and appliances, and the likelihood that building 22, or a particular room within building 22, will continue to be occupied for some length of time. For example, the level of power consumed within building may be directed related to the amount of heat that is generated in the near future by the machines and appliances. Processor 30 may factor this generated heat into its decisions regarding whether HVAC system 36 should be operated to provide heat or air conditioning.

As another example of a characteristic that energy consumption sensing devices 26 may identify, different types of loads may result in different phases in the supplied power. Inductive loads such as motors, for example, may cause a leading phase shift of about ninety degrees. Capacitive loads such as battery chargers may cause a trailing phase shift of about ninety degrees. A resistive load typically causes little or no phase shift. Thus, processor 30 may analyze phase shifts and make assumptions about the type of machines and appliances being operated. From this information, processor 30 may also draw conclusions as to the expected human occupancy behavior and/or the amount of heat to be generated by the machines and appliances. On this basis, processor 30 may control the operation of HVAC system 36. Of course, it may not be necessary for processor 30 to make assumptions about the type of machines and appliances being operated. Rather, processor 30 may use trends in historic data to directly interpret the likely effect of certain types of phase shifts on human occupancy and heat generation during the subsequent several hours.

In addition to phase shift, another electrical characteristic that may be sensed and analyzed by processor 30 is the harmonic frequency components generated by the machines and appliances in the power lines or radiated into the air. Processor 30 may make assumptions as to expected human occupancy behavior and/or the amount of heat to be generated by the machines and appliances based on such detected harmonic frequency components. Processor 30 may then control HVAC system 36 accordingly.

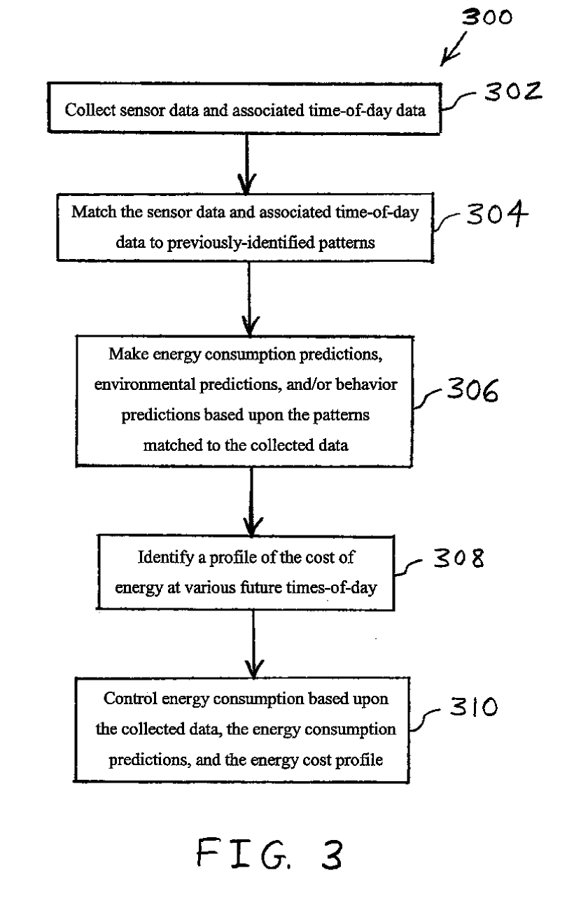

One embodiment of a method 300 of the present invention for controlling energy consumption within a building is illustrated in FIG. 3. In a first step 302, sensor data and associated time-of-day data is collected. For example, processor 30 may receive sensor data from energy consumption sensing devices 26 and environment sensing devices 28 and may match this sensor data with time-of-day data that processor 30 receives from the Internet 34 or generates with an internal clock.

In a next step 304, the sensor data and associated time-of-day data is matched to previously identified patterns. That is, processor 30 may search through previously collected data, or previous data that has been downloaded into processor 30 from another source, and identify portions of that historic data that are similar to the recently collected sensor data.

Next, in step 306, energy consumption predictions, environmental predictions, and/or behavior predictions may be made based upon the patterns matched to the collected data. For example, processor 30 may identify patterns in the historic data from sensors 26, 28 that immediately follows the historic data that matches the current data, and processor 30 may assume that the future data immediately following the current sensor data will follow a similar pattern as the historic data. That is, processor 30 may extrapolate the current data to match identified patterns in the historic data. On this basis, processor 30 may make predictions as to future sensor readings, and these predicted future sensor readings may be directly related to predictions for energy consumption, environmental conditions, and/or occupant behavior inside and outside building 22.

In step 308, a profile of the cost of energy at various future times-of-day is identified. In one embodiment, processor 30 may periodically download from Internet 34 or otherwise receive the various costs per kilowatt-hour of electricity as charged by the electric company at each hour of the day.

In a final step 310, energy consumption is controlled based upon the collected data, the energy consumption predictions, and the energy cost profile. That is, processor 30 may decide whether or not to operate HVAC system 36 and/or may decide whether, or at what time-of-day, to operate appliances 38 in a cost efficient way that does not significantly sacrifice comfort and/or convenience for occupants of building 22. Processor 30 may make these decisions based upon data collected from sensing devices 26, 28, the predictions regarding energy consumption, environmental conditions, and/or occupant behavior, and the cost of energy at various hours of the day.

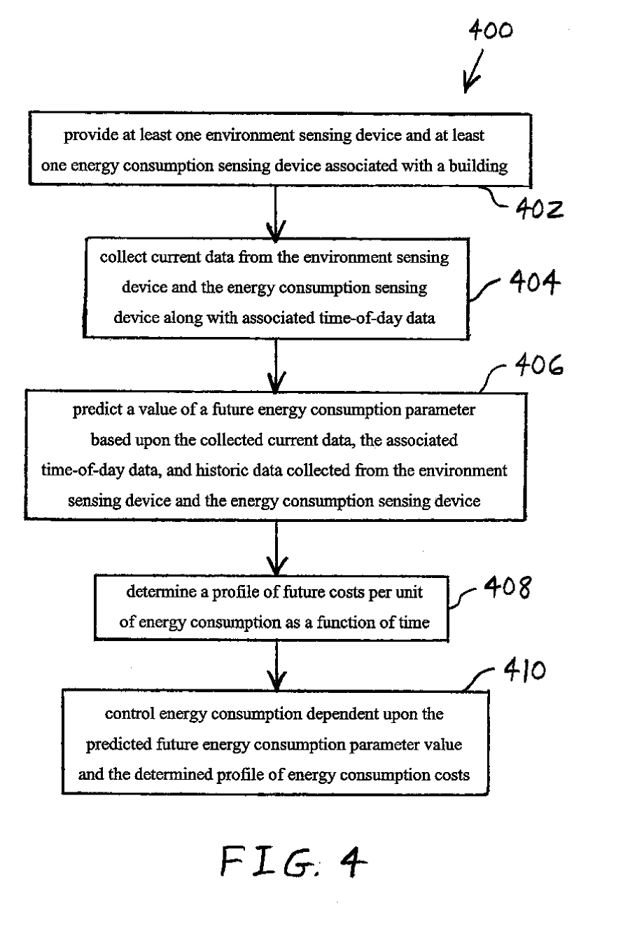

Another embodiment of a method 400 of the present invention for controlling energy consumption within a building is illustrated in FIG. 4. In a first step 402, at least one environment sensing device and at least one energy consumption sensing device associated with a building are provided. For example, environment sensing devices 28 and energy consumption sensing devices 26 may be provided in building 22.

In a next step 404, current data is collected from the environment sensing device and the energy consumption sensing device along with associated time-of-day data. For example, processor 30 may receive sensor data from energy consumption sensing devices 26 and environment sensing devices 28 and may match this sensor data with time-of-day data that processor 30 receives from the Internet 34 or generates with an internal clock.

Next, in step 406, a future value of an energy consumption parameter is predicted based upon the collected current data, the associated time-of-day data, and historic data collected from the environment sensing device and the energy consumption sensing device. For example, processor 30 may identify patterns in the historic data from sensors 26, 28 that immediately follows the historic data that matches the current data. Processor 30 may then assume that the future values of energy consumption parameters, as provided by future readings of sensing devices 26, 28, will follow a similar pattern as the historic data. That is, processor 30 may extrapolate the current data to match identified patterns in the historic data. On this basis, processor 30 may make predictions as to future values of energy consumption parameters related to energy consumption, environmental conditions, and/or occupant behavior inside and outside building 22.

In a next step 408, a profile of future costs per unit of energy consumption as a function of time is determined. For example, processor 30 may periodically download from Internet 34 or otherwise receive the various costs per kilowatt-hour of electricity as charged by the electric company at each hour of the day.

In a final step 410, energy consumption is controlled dependent upon the predicted future energy consumption parameter value and the determined profile of energy consumption costs. That is, processor 30 may decide whether or not to operate HVAC system 36 and/or may decide whether, or at what time-of-day, to operate appliances 38 in a cost efficient way that does not significantly sacrifice comfort and/or convenience for occupants of building 22. Processor 30 may make these decisions based upon data collected from sensing devices 26, 28, the predictions regarding energy consumption, environmental conditions, and/or occupant behavior, and the cost of energy at various hours of the day.

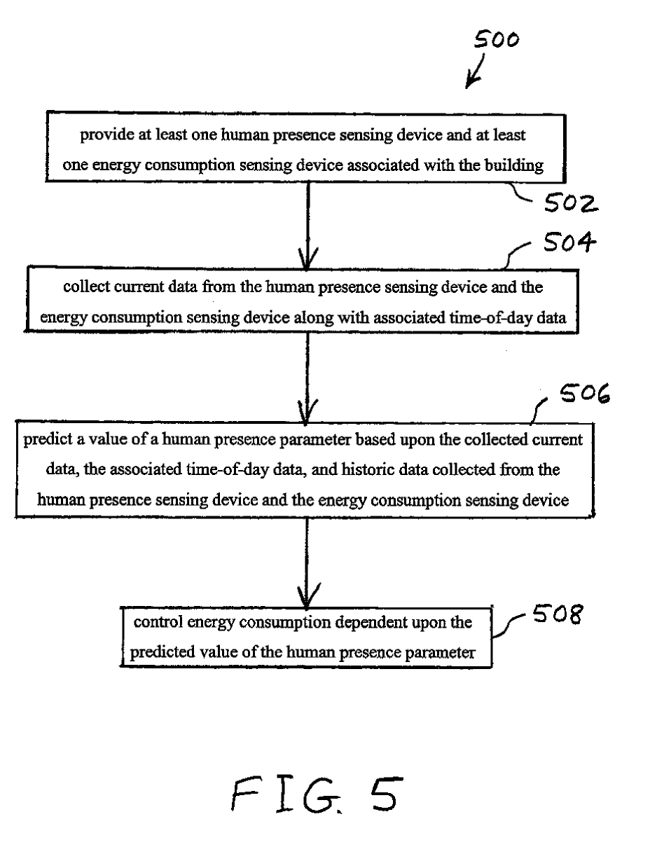

Yet another embodiment of a method 500 of the present invention for controlling energy consumption within a building is illustrated in FIG. 5. In a first step 502, at least one human presence sensing device and at least one energy consumption sensing device associated with a building are provided. For example, energy consumption sensing devices 26 as well as environment sensing devices 28 in the form of sound detectors, motion detectors, and/or carbon dioxide detectors may be provided in building 22. These types of environment sensing devices 28 may all be capable of detecting human presence.

In a next step 504, current data is collected from the human presence sensing device and from the energy consumption sensing device along with associated time-of-day data. For example, processor 30 may receive sensor data from energy consumption sensing devices 26 and from environment sensing devices 28 that are capable of detecting human presence and may match this sensor data with time-of-day data that processor 30 receives from the Internet 34 or generates with an internal clock.

Next, in step 506, a future value of a human presence parameter is predicted based upon the collected current data, the associated time-of-day data, and historic data collected from the human presence sensing device and the energy consumption sensing device. For example, processor 30 may identify patterns in the historic data from sensors 28 that immediately follows the historic data that matches the current data. Processor 30 may then assume that the future values of human presence parameters, as provided by future readings of sensing devices 28, will follow a similar pattern as the historic data. That is, processor 30 may extrapolate the current data to match identified patterns in the historic data. On this basis, processor 30 may make predictions as to future values of human presence parameters related to energy consumption, environmental conditions, and/or occupant behavior inside and outside building 22. In one embodiment, the human presence parameter may be in the form of a number of occupants of building at various times-of-day. This human presence parameter may be broken down on a room-by-room basis.

In a final step 508, energy consumption is controlled dependent upon the predicted future human presence parameter value. That is, processor 30 may decide whether or not to operate HVAC system 36 and/or may decide whether, or at what time-of-day, to operate appliances 38 in a cost efficient way that does not significantly sacrifice comfort and/or convenience for occupants of building 22. Processor 30 may make these decisions based upon data collected from sensing devices 26, 28, the predictions regarding human presence, environmental conditions, and/or occupant behavior. In one embodiment, processor 30 may also consider the cost of energy at various hours of the day in making these decisions about the control of energy consumption.

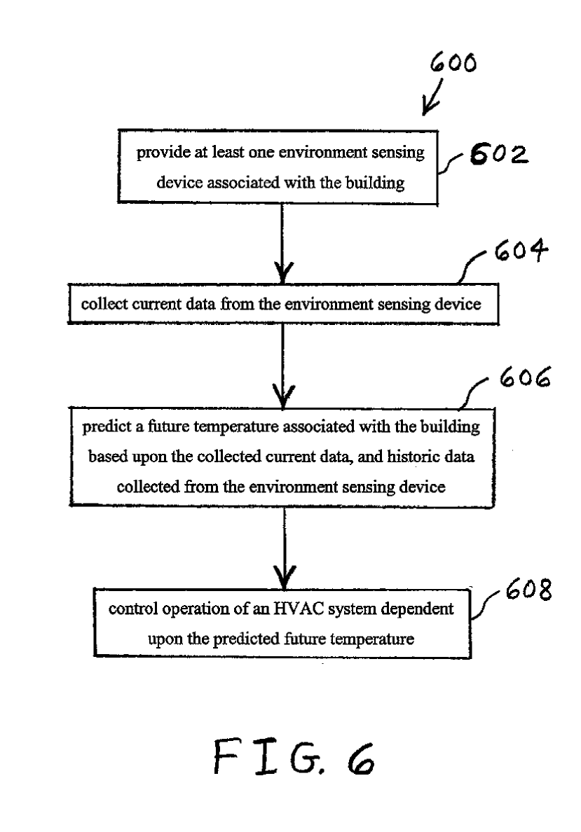

An embodiment of a method 600 of the present invention for controlling HVAC operation within a building is illustrated in FIG. 6. In a first step 602, at least one environment sensing device associated with a building is provided. For example, environment sensing devices 28 in the form of ambient temperature detectors may be provided within building 22 and/or outside of building 22.

In a next step 604, current data is collected from the environment sensing device. For example, processor 30 may receive temperature data from one or more environment sensing devices 28 in the form of ambient temperature detectors disposed in various rooms 24 of building 22 and/or outside of building 22.

Next, in step 606, a future temperature associated with the building is predicted based on the current collected data, and historic data collected from the environment sensing device. For example, processor 30 may identify patterns in the historic data from temperature sensors 28 that immediately follows the historic data that matches the current temperature data. Processor 30 may then assume that the future temperatures, as provided by future readings of sensing devices 28, will follow a similar pattern as the historic data. That is, processor 30 may extrapolate the current data to match identified patterns in the historic data. On this basis, processor 30 may make predictions as to future temperatures within building 22. In one specific embodiment, processor 30 may receive both an outside temperature and a temperature inside building 22. Based on the difference between the outside temperature and the inside temperature, processor 30 may predict a future inside temperature (e.g., within the next several hours) based on historical rates of temperature change, assuming no operation of HVAC system 36 in the interim. The temperature differences and temperature predictions may be broken down on a room-by-room basis.

It is possible for processor 30 to take into account additional variables when forming predictions of future inside temperatures. For example, processor 30 may receive data from other types of environment sensors 28, such as outside wind sensors, outside moisture sensors for detecting rain or frozen precipitation, outside light sensors for detecting intensity of sunlight, sensors to detect whether drapes are in open positions such that they allow sunlight to enter rooms 24 through windows, inside light sensors for detecting sunlight entering rooms 24, outside and/or inside humidity sensors, ground temperature sensors, human presence sensors given that human bodies tend to radiate significant heat and raise the temperature within buildings, and detectors to sense whether, to what degree, and for what time duration, windows and doors are kept open, which enables outside air to enter building 22. It is further possible for processor 30 to receive some types of environmental data on-line via Internet 34. Such on-line data may include present outside temperature, predicted outside temperature, and other current or future weather conditions. Other parameters that processor 30 may take into account when forming predictions of future inside temperatures may be received from energy consumption sensing devices 26. For example, sensing devices 26 may detect the total electrical power being consumed within building 22 in order to enable processor 30 to estimate the amount of heat that will be generated by such power consumption.

In a final step 608, operation of an HVAC system is controlled dependent upon the predicted future temperature. That is, processor 30 may decide whether or not to operate HVAC system 36 such that costs may be reduced without significantly sacrificing the comfort of occupants of building 22. Processor 30 may make these decisions based upon data collected from sensing devices 26, 28, the predictions regarding future temperatures, environmental conditions, and/or occupant behavior. In one embodiment, processor 30 may also consider the cost of energy at various hours of the day in making these decisions about the operation of HVAC system 36.

As described above, processor 30 may analyze patterns of previous data collected within building 22 in order to extrapolate current data and make some predictions regarding future data. However, it is also possible within the scope of the invention for processor 30 to be provided with a database of previous data collected from other similar buildings to analyze. In another embodiment, processor 30 does not perform any data analysis, but rather inputs the available data into a lookup table and operates the HVAC system according to the output of the lookup table.

The present invention has been described herein with reference to energy consumption predictions, environmental predictions, and behavior predictions derived from matching currently observed sensor data to previously observed patterns in the data and extrapolating this information to future points in time. However, it is to be understood that the scope of the present invention includes viewing the predictions as outputs from models of consumption, behavior, etc. that are constructed and learned from the historical data. That is, sensors may measure a multitude of parameters, as described hereinabove, and these parameters may be used to derive a statistical model of user behavior and the environment where upcoming states depend on current and previous states. This model based-approach is of course similar to the other embodiments described hereinabove. It is to be understood that sensor-based behavioral modeling, which may suggest more understanding of the underlying user behavior as opposed to data extrapolation, is also within the scope of the invention.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. A method for controlling energy consumption within a building, the method comprising the steps of:
providing at least one environment sensing device and at least one energy consumption sensing device associated with the building;
collecting current data from the environment sensing device and the energy consumption sensing device along with associated time-of-day data;
predicting a future value of an energy consumption parameter based upon the collected current data, the associated time-of-day data, and historic data collected from the environment sensing device and the energy consumption sensing device;
determining a profile of future costs per unit of energy consumption as a function of time; and
controlling energy consumption dependent upon the predicted future energy consumption parameter value and the determined profile of energy consumption costs.

2. The method of claim 1 wherein the building includes a plurality of rooms, the future value of the energy consumption parameter being predicted on a room-by-room basis, and the energy consumption being controlled on a room-by-room basis.

3. The method of claim 1 wherein the predicted energy consumption parameter value corresponds to a time that is less than twenty-five hours into the future, and the profile of future costs per unit of energy consumption as a function of time has a horizon of less than twenty-five hours.

4. The method of claim 1 wherein the controlling step includes selecting a future time at which a rate of energy consumption is to be changed.

5. The method of claim 1 wherein the energy consumption parameter comprises a human presence parameter.

6. The method of claim 1 wherein the energy consumption parameter comprises an ambient temperature within the building.

7. The method of claim 1 wherein the environment sensing device comprises at least one of a motion detector, sound detector, carbon dioxide detector, door movement detector, and electronic card reader.

8. A method for controlling energy consumption within a building, the method comprising the steps of:
providing at least one human presence sensing device and at least one energy consumption sensing device associated with the building;
collecting current data from the human presence sensing device and the energy consumption sensing device along with associated time-of-day data;
predicting a future value of a human presence parameter based upon the collected current data, the associated time-of-day data, and historic data collected from the human presence sensing device and the energy consumption sensing device; and
controlling energy consumption dependent upon the predicted future value of the human presence parameter.

9. The method of claim 8 comprising the further step of determining a profile of future costs per unit of energy consumption as a function of time, the controlling step being dependent upon the determined profile of energy consumption costs.

10. The method of claim 8 wherein the building includes a plurality of rooms, the future value of the human presence parameter being predicted on a room-by-room basis, and the energy consumption being controlled on a room-by-room basis.

11. The method of claim 8 wherein the human presence parameter comprises a number of persons in the building.

12. The method of claim 8 wherein the predicting step includes identifying a trend in the historic data and extrapolating the collected current data based on the trend.

13. The method of claim 8 wherein the trend includes future changes in the human presence parameter as a function of a characteristic of the energy consumption sensed by the energy consumption sensing device.

14. The method of claim 8 wherein the controlling step includes selecting at least one of a future time at which a rate of energy consumption is to be changed and a change in the rate of energy consumption.

15. A method for controlling HVAC operation within a building, the method comprising the steps of:
providing at least one environment sensing device associated with the building;
collecting current data from the environment sensing device;
predicting a future temperature associated with the building based upon the collected current data, and historic data collected from the environment sensing device; and
controlling operation of an HVAC system dependent upon the predicted future temperature.

16. The method of claim 15 comprising the future steps of:
providing at least one energy consumption sensing device associated with the building; and
collecting current data from the energy consumption sensing device;
wherein the future temperature associated with the building is predicted based upon the collected current data, and historic data collected from the energy consumption sensing device.

17. The method of claim 15 comprising the further step of determining a profile of future costs per unit of energy consumption as a function of time, the controlling step being dependent upon the determined profile of energy consumption costs.

18. The method of claim 15 wherein the building includes a plurality of rooms, the future temperature associated with the building being predicted on a room-by-room basis, and the energy consumption being controlled on a room-by-room basis.

19. The method of claim 15 wherein the future temperature associated with the building is predicted based upon the HVAC system being idle between a time of the predicting step and a time of the future temperature.

20. The method of claim 15 comprising the further step of predicting a future value of a human presence parameter, the operation of the HVAC system being controlled dependent upon the predicted future value of the human presence parameter.
